(19) United States
(12) Patent Application Publication
(10) Pub. No.: US 2024/0018670 A1
(43) Pub. Date: Jan. 18, 2024

(54) SYSTEMS, METHODS AND APPARATUS FOR PRODUCING AN ELECTROLYSIS GAS, HYDROGEN GAS, A HYDROGEN STORAGE AND DELIVERY SYSTEM AND STORAGE CANISTER

(71) Applicant: ECO-GLOBAL ENERGY PTY LIMITED, Sylvania, New South Wales (AU)

(72) Inventor: Spiro Spiros, Mascot, New South Wales (AU)

(73) Assignee: ECO-GLOBAL ENERGY PTY LIMITED, Sylvania, New South Wales (AU)

(21) Appl. No.: 18/255,623

(22) PCT Filed: Nov. 29, 2021
(86) PCT No.: PCT/AU2021/051422

§ 371 Date: Jun. 2, 2023

(30) Foreign Application Priority Data
Dec. 2, 2020 (AU) 2020904466
Jun. 16, 2021 (AU) 2021901808

(51) Int. Cl. C25B 9/70; C25B 9/015; C25B 1/04; C25B 9/63; C25B 11/02; F17C 11/00; C01B 3/50; C01B 3/00

(52) U.S. Cl. CPC C25B 9/70; C25B 9/015; C25B 1/04; C25B 9/63; C25B 11/02; F17C 11/005; C01B 3/501; C01B 3/001; F17C 2221/012; F17C 2270/0184; F17C 2270/0178; F17C 2205/0323; F17C 2227/0304; C01B 2203/0405

(57) ABSTRACT

Described herein is an electrolysis cell apparatus (2000) comprising an outer enclosure (100) for containing an electrolyte solution, the outer enclosure (100) has a first end (100A), a second end (100B) and an intermediate enclosure section (100M) located between the first and second end (100A), (100B) a plurality of electrolysis cell plates (80) forming at least one electrolysis region in which electrolysis occurs, housed within the outer enclosure (100) and at least partially immersed in an electrolyte solution; and a cell plate enclosure (8000) disposed within the outer enclosure (100) that at least partially encloses the plurality of electrolysis cell plates (80), wherein the cell plate enclosure (8000) is adapted to concentrate electrolyte ions in close proximity to the plurality of electrolysis cell plates (80) in use.

### FIELD OF THE INVENTION

The present application relates to systems for producing an electrolysis gas, as well as a system for extracting hydrogen from the electrolysis gas and storing and delivering the hydrogen.

Embodiments of the present invention are particularly adapted for the generation of electrolysis gas and subsequently hydrogen for use in hydrogen fuel cells and other products. However, it will be appreciated that the invention is applicable in broader contexts and other applications.

### BACKGROUND

Presently, systems that can be used for generating electrolysis gasses tend to be bulky and use expensive materials to fabricate electrolysis cell plates. Furthermore, due to the process of electrolysis, the plates tend to erode over time necessitating their replacement and reducing reliability. Given that the electrolysis cell plates are typically made out of expensive materials such as stainless steel or titanium among others, the cost of assembling electrolysis cells is typically high. This adds a significant amount to the operational costs of such a system.

Further issues arise in the fabrication of electrolysis cell arrangements, which at present tend to be tedious and time consuming. For instance, it can take multiple weeks to construct conventional electrolysis cell arrangements due to the large number of components required to be individually assembled. As such, the inventor has identified that an efficient method of constructing electrolysis cell arrangements is desirable.

It is desirable to have systems for generating electrolysis gasses which are reliable, resulting in a lengthy operational life and may be made from inexpensive materials.

Furthermore, current systems for storing and delivering hydrogen require the hydrogen to be maintained under a very high pressure such as 10,000 PSI (˜69,000 KPa). Storing materials at such high pressures can be dangerous as they have a risk of explosion.

Any discussion of the background art throughout the specification should in no way be considered as an admission that such art is widely known or forms part of common general knowledge in the field.

### SUMMARY OF THE INVENTION

In accordance with a first aspect of the present invention, there is provided an electrolysis cell apparatus comprising:
an outer enclosure for containing an electrolyte solution, the outer enclosure having a first end, a second end and an intermediate enclosure section located between the first and second end;
a plurality of electrolysis cell plates forming at least one electrolysis region in which electrolysis occurs, housed within the outer enclosure and at least partially immersed in an electrolyte solution; and
a cell plate enclosure disposed within the outer enclosure that at least partially encloses the plurality of electrolysis cell plates, wherein the cell plate enclosure is adapted to concentrate electrolyte ions in close proximity to the plurality of electrolysis cell plates in use.

In one embodiment, the plurality of electrolysis cell plates are divided into cell plate sections between the first end and the second end, the cell plate sections being electrically connected in series.

In one embodiment, the cell plate sections proximal to the intermediate enclosure section comprise a different number of electrolysis cell plates compared to the cell plate sections proximal to either of the first end or the second end of the enclosure.

In one embodiment, each cell plate section is spaced by an interconnecting spacer made of a dielectric material designed to house and locate the cell plate enclosure.

In one embodiment, a longitudinal compressional force is applied to the plurality of electrolysis cell plates to provide a snug fit between conducting spacer elements and the plurality of electrolysis cell plates forming at least one electrolysis region.

In one embodiment, the plurality of electrolysis cell plates are shaped to define a uniform gap between the cell plate enclosure and outer edges of the electrolysis cell plates.

In one embodiment, each electrolysis region includes a pair of enclosure elements, providing an upper channel and a lower channel extending along the length of each electrolysis region.

In one embodiment, the electrolysis cell apparatus includes one or more electrolyte injection devices which include a plurality of openings adapted to inject an electrolytic fluid within the lower channels of each electrolysis region.

In one embodiment, the one or more electrolyte injection devices is comprised of a dielectric material.

In one embodiment, the dielectric material includes polypropylene.

In one embodiment, the dielectric material includes PTFE.

In one embodiment, the apparatus includes a gap between the outer enclosure and the cell plate enclosure.

In one embodiment, there is provided a system for generating an electrolysis gas, the system comprising the electrolysis cell.

In one embodiment, the system further includes at least one electrical power source operatively connected to the at least one electrolysis region and adapted to alternate its electrical polarity.

In one embodiment, a compound is included within the electrolyte to promote the formation of a hydride on the electrolysis cell plates and/or electrolysis enclosures in use.

In one embodiment, the electrolyte includes 15% wt potassium hydroxide.

In one embodiment, the electrolyte includes 15% wt sodium hydroxide.

In one embodiment, the electrolyte includes protium water.

In one embodiment, including a plurality of electrolysis regions and wherein the electrolysis regions are electrically connected in series, disposed along the length of the electrolysis cell apparatus.

In one embodiment, each of the electrolysis regions include an upper channel disposed for permitting a flow of electrolysis gas generated by each electrolysis region to a gas outlet.

In one embodiment, the electrolysis regions include a lower channel for accommodating an electrolytic fluid device to be housed along a lower region of the outer enclosure to an inlet.

In one embodiment, the electrolysis cell unit enclosure elements include a lower channel for permitting electrolytic fluid to flow along the lower region of the outer enclosure to an outlet.

In one embodiment, there is provided a gas produced by the system for generating an electrolysis gas.

In one embodiment, the gas comprises molecular oxygen.

In one embodiment, the gas comprises molecular hydrogen.

In one embodiment, the gas comprises a mixture of molecular oxygen and molecular hydrogen.

In one embodiment, the generated electrolysis gas comprises a Hydrogen, Oxygen, Nitrogen, Carbon Dioxide and Water Vapour mixture, this gas composition is henceforth referred to as Hydroxy Gas.

In accordance with a second aspect of the present invention, there is provided a method for assembling an electrolysis region, the method comprising the following steps:
providing a support member with a first fastening device;
introducing a first termination cell plate to the support member;
introducing a conducting spacer element to the termination cell plate;
introducing a first electrolysis cell plate to the conducting spacer element with an electrically insulated grommet fitted to an aperture of the cell plate;
introducing an electrolysis cell plate to the conducting spacer element;
introducing an intermediate conducting spacer element which is adapted to interference fit to the conducting spacer element and subsequent intermediate conducting spacer elements;
introducing an electrolysis cell plate to the intermediate conducting spacer element with an electrically insulated grommet fitted to the electrolysis cell plate aperture;
introducing an electrolysis cell plate to the intermediate conducting spacer element;
repeating the process in steps f to h until the desired number of electrolysis cell plates is achieved;
introducing a final termination cell plate to the support member; and
introducing longitudinal pressure to press fit the conducting spacer elements and electrolysis cell plates in the electrolysis cell assembly;
introducing a second fastening device to the support member.

In one embodiment, an electrolysis cell apparatus is constructed by performing the method of the second aspect.

In accordance with a third aspect of the present invention, there is provided a system for generating and storing hydrogen gas, the system including:
an electrolysis system for generating an electrolysis gas;
a separation module for separating hydrogen gas (H₂) from the electrolysis gas; and
a hydrogen storage module for receiving the hydrogen gas;
wherein the hydrogen storage module includes one or more storage canisters containing a hydrogen storage compound for bonding with the received hydrogen gas to store hydrogen in a stable environment.

Preferably, the electrolysis gas includes hydroxy gas.

In some embodiments, the electrolysis system is the system for generating an electrolysis gas according to the third aspect.

In some embodiments, the hydrogen is stored in the hydrogen storage module as a hydride.

In some embodiments, the hydrogen storage compound includes Titanium carbide (TIC) powder.

In other embodiments, the hydrogen storage compound includes TiCH₂.

In some embodiments, the one or more storage canisters are adapted to selectively distribute hydrogen to one or more hydrogen fuel cells to generate electric energy.

Preferably, the one or more hydrogen fuel cells are configured to be used in a vehicle.

In accordance with a fourth aspect of the present invention, there is provided a method of generating and storing hydrogen gas, the method including the steps:
performing electrolysis on an electrolyte solution to generate an electrolysis gas;
separating hydrogen gas from the electrolysis gas using a hydrogen separator;
storing the hydrogen gas in a storage module, wherein the storage module includes one or more canisters containing a hydrogen storage compound for bonding with the received hydrogen gas to store hydrogen in a stable environment.

Preferably, the hydrogen is stored in a hydrogen storage module as a hydride.

In some embodiments, the hydrogen is stored in the hydrogen storage module as a hydride.

In some embodiments, the hydrogen storage compound includes Titanium carbide (TIC) powder.

In other embodiments, the hydrogen storage compound includes TiCH₂.

In some embodiments, the hydrogen storage module stored the hydrogen in the hydrogen storage compound at a pressure less than 690 KPa.

In accordance with a fifth aspect of the present invention, there is provided a portable hydrogen storage canister including:
a sealed protective housing defining an internal sealed storage chamber; an inlet port for selectively allowing ingress of hydrogen gas to the storage chamber;
a hydrogen storage compound disposed within the storage chamber and configured to bond with hydrogen gas to store hydrogen within the canister; and
an outlet port for selectively allowing egress of hydrogen gas from the storage chamber.

In some embodiments, the hydrogen storage compound includes Titanium carbide (TIC) powder.

In other embodiments, the hydrogen storage compound includes TiCH₂.

In some embodiments, the canister includes a heating element configured to selectively heat a temperature of the storage chamber to release hydrogen gas from the hydrogen storage compound.

In some embodiments, the heating element includes an electrically controlled heating device.

In some embodiments, the heating element includes or is connected to a system for feeding excess heat from an electrolysis system and/or a fuel cell system to the canister.

In some embodiments, wherein the storage chamber has a pressure of less than 690 KPa. In some embodiments, the storage chamber has a pressure of less than 345 KPa.

In some embodiments, the storage chamber has a temperature of less than 100 degrees Celsius.

In accordance with a sixth aspect of the present invention, there is provided a fuel cell configured to receive hydrogen from the canister according to the seventh aspect to produce electrical energy.

### BRIEF DESCRIPTION OF THE FIGURES

Example embodiments of the disclosure will now be described, by way of example only, with reference to the accompanying drawings in which:

FIG. 1 shows a schematic system-level diagram of the system for generating an electrolysis gas;

FIG. 2 shows an electrolysis cell plate in accordance with an embodiment of the present invention;

FIG. 3 shows side and plan views of an insulating element in accordance with an embodiment of the present invention;

FIG. 4 schematically exemplifies a process for assembling the electrolysis cell units;

FIG. 5 shows a cross-sectional view of the cell plate enclosure in accordance an embodiment of the invention;

FIG. 6A shows side sectional view of a cell plate attached to a cell plate enclosure in accordance with an embodiment of the present invention;

FIG. 6B shows a plan view of a cell plate attached to a cell plate enclosure in accordance with an embodiment of the present invention;

FIG. 7 shows a longitudinal cross sectional view of a section of the electrolysis tube of FIG. 10;

FIG. 8 shows a cross sectional view of the electrolysis tube of FIG. 10;

FIG. 9 shows an electrolyte injection system in accordance with the present invention;

FIG. 10 shows a side view of an electrolysis tube in accordance with an embodiment of the present invention;

FIG. 11 shows a detailed view of an end segment of the electrolysis tube shown in FIG. 10;

FIG. 12 shows an end of the electrolysis tube of FIG. 10;

FIG. 13 is a system level diagram of a system for generating and storing hydrogen using an electrolysis system to generate hydroxy gas; and

FIG. 14 is a side view of a hydrogen storage canister.

### DESCRIPTION OF EMBODIMENTS OF THE INVENTION

It should be noted in the following description that like reference numerals in different embodiments denote the same or similar features.

Embodiments of the invention described herein are adapted for producing hydroxy gas. This hydroxy gas is suitable for use in various applications such as combustion and pyrolysis. By way of example, hydroxy gas produced from the present invention may be used in a combustion and pyrolysis system as described in PCT/AU2020/050663, entitled AN APPARATUS, SYSTEM AND METHOD FOR PYROLYSING AND COMBUSTING A MATERIAL to Spiro Spiros (“Spiros”). The contents of Spiros are herein incorporated by way of cross-reference. When injected into the tungsten reaction tubes of the Spiros system, the hydroxy gas produced by the present invention can be heated to a sufficient degree that gases of atomic oxygen (single oxygen atoms) and atomic hydrogen (single hydrogen atoms) is produced for high temperature pyrolysis.

Electrolysis Cell Apparatus

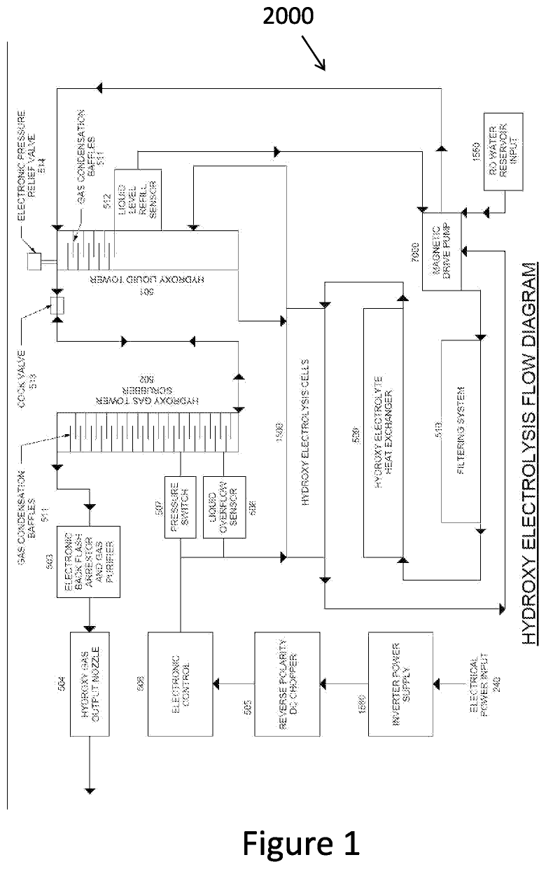

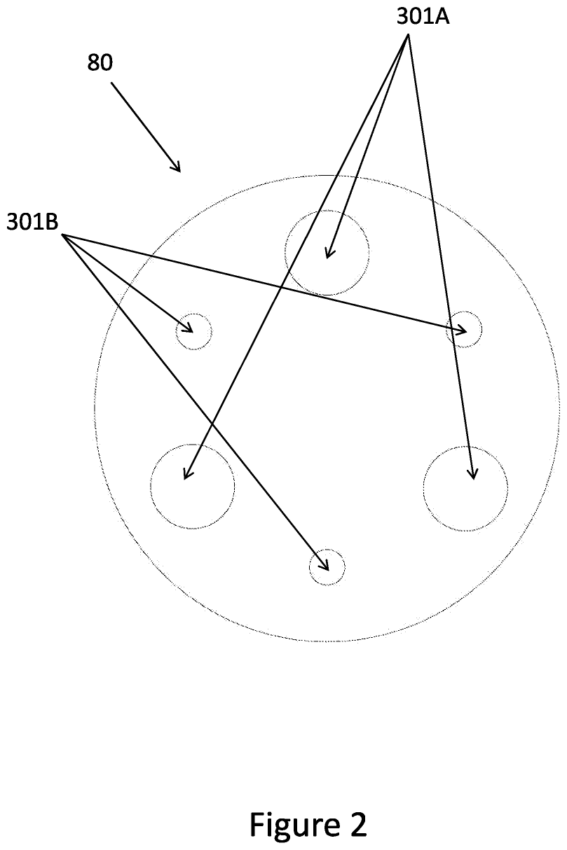

An electrolysis cell apparatus in accordance with an embodiment of the present invention is generally indicated by 2000 in FIG. 1. In the embodiment shown in FIGS. 1 and 2, the electrolysis tube 1500 comprises an outer enclosure 100 (also referred to as cylinder enclosure in the Figures) for containing a potassium hydroxide or sodium hydroxide electrolyte solution. The outer enclosure 100 is typically manufactured from a metallic material such as steel and may take a variety of shapes. In the embodiment shown, the outer enclosure 100 is generally cylindrical in shape and is around 140 mm in diameter and around 2.3 meters in length. In other embodiments, the outer enclosure may take other shapes such as a structure with square or rectangular cross sections. An advantage of using a cylindrical outer enclosure is that cylindrical piping is readily available. In the embodiment shown, the electrolysis cell plates 80 are circular in cross sectional profile and designed to be rotated into particular orientations, which will be discussed further. Although in many embodiments, a cylindrical shape may be preferable, it will be appreciated that cell plates having other cross sectional profiles may be used, such as a square profile.

The outer enclosure 100 has three reference points, a first end 100A, a second end 100B and an intermediate enclosure section 100M located between the first and second end. In the embodiment shown, the number of electrolysis cell plates 80 proximal to the intermediate enclosure section 100M are less than the number of electrolysis cell plates 80 proximal to the first end 100A and the second end 100B. The inventor has found through experimental analysis, less cell activity occurs proximal to the intermediate enclosure section 100M compared to either the first end 100A or the second end 100B, allowing for less electrolysis cell plates to be used proximal to the intermediate section 100M as compared to either of the first end and the second end.

As was previously mentioned, the electrolysis tube 1500 is further comprised of a plurality of electrolysis cell plates 80 which are housed within the outer enclosure 100.

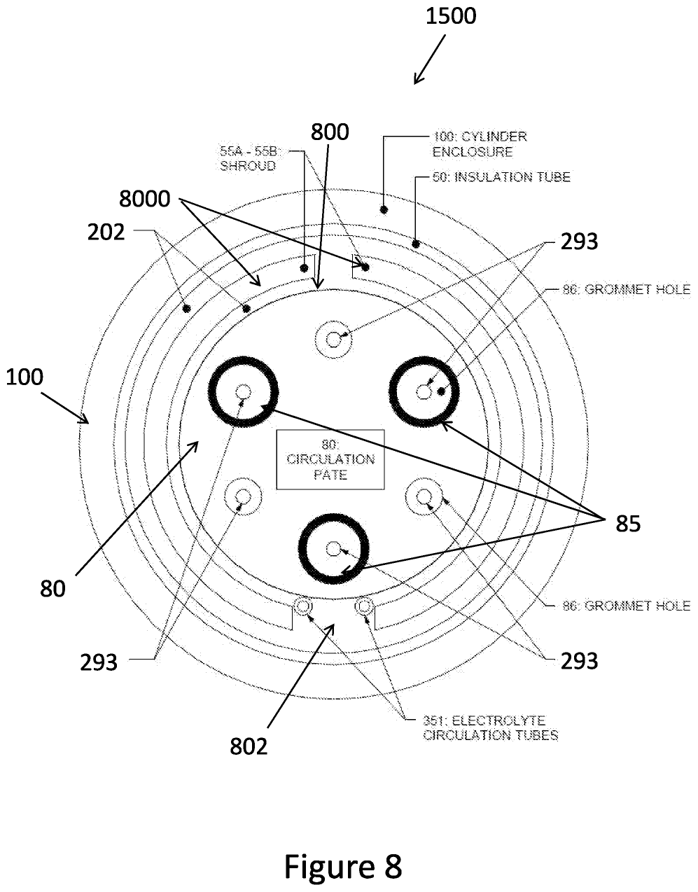

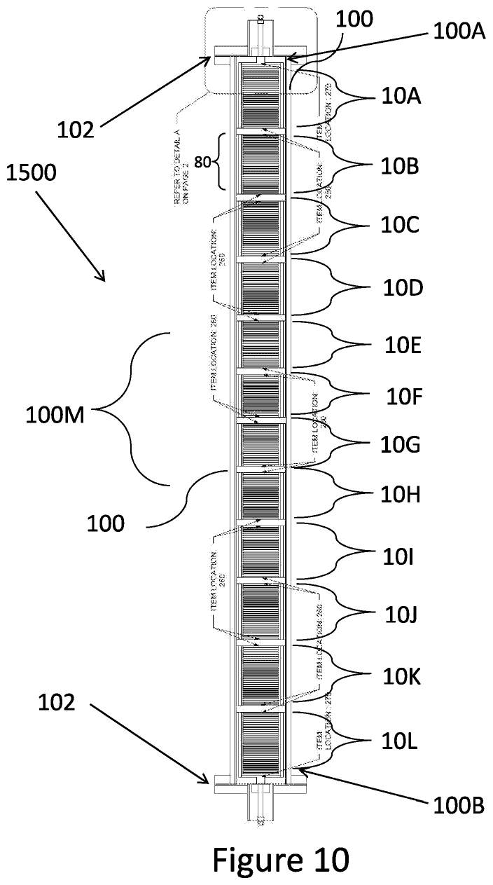

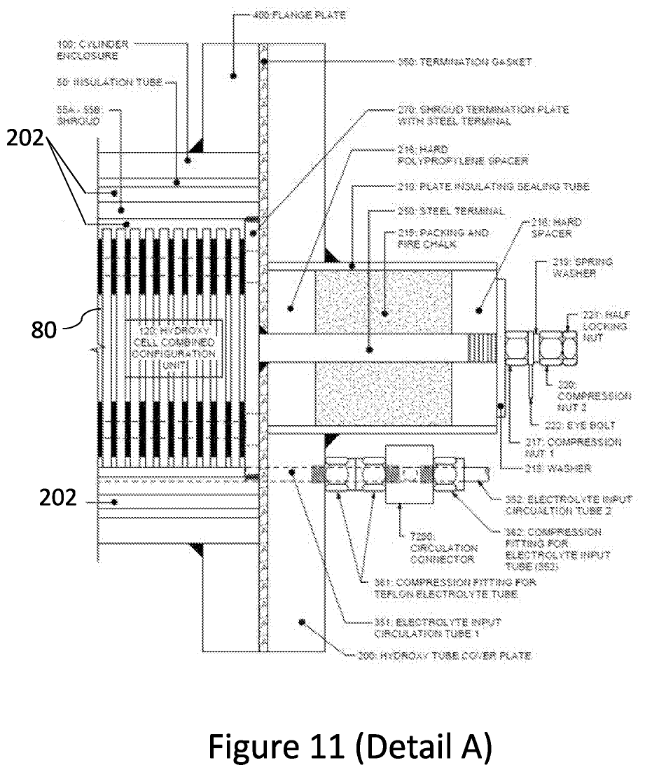

As best shown in FIG. 8, in the embodiment shown, the electrolysis cell plates 80 are circular disks and arranged in a stacked configuration as shown in FIGS. 2 and 11. In the arrangement shown, the electrolysis cell plates 80 are disposed linearly along a central longitudinal axis of the electrolysis tube 1500 and separated into a number of longitudinally spaced cell plate sections referred to as cells 10A to 10L, as best shown in FIG. 10.

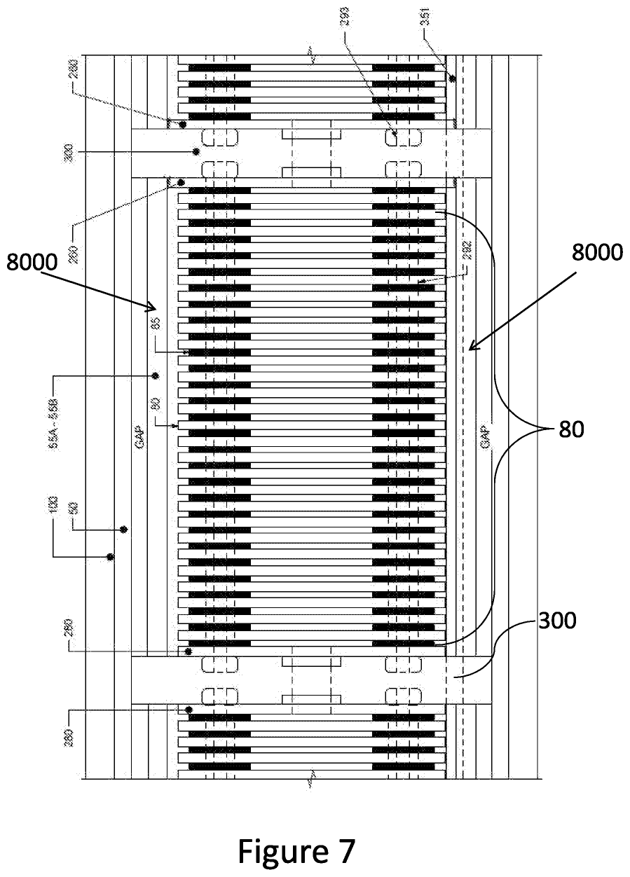

With reference to FIG. 7, each of the longitudinally spaced cells 10A to 10L are separated by interconnecting spacers 300. The interconnecting spacers 300 may be fabricated out of a variety of dielectric materials such as polypropylene or PTFE (TEFLON®) as a couple of examples.

As best shown in FIG. 2, the electrolysis cell plates 80 are situated in close proximity to each other being disposed in a position parallel to each of the other electrolysis cell plates 80. Each plate extends substantially perpendicular to the longitudinal axis of enclosure 100. The electrolysis cell plates 80 are arranged such that each subsequent electrolysis cell plate 80 has an opposite voltage polarity to the one that preceded it by appropriate connections to a voltage source (described below).

As is exemplified in FIG. 2, each electrolysis cell plate 80 contains a plurality of apertures 301A, 301B which are required for the assembly of the electrolysis cell plates 80. In the embodiment shown, the plurality of apertures 301A, 301B take two different sizes and are circular in shape. In particular, apertures 301A have a larger diameter than that of apertures 301B. The importance of the apertures 301A, 301B in the assembly of the electrolysis tube 1500 will be described in more detail below in relation to the manufacture and assembly of the electrolysis tube 1500.

With reference to FIG. 10, the plurality of electrolysis cell plates 80 may range in number typically between 18 to 36 cell plates 80, which are divided out into 12 longitudinally separated cells 10A to 10L in total in the embodiment shown. Each of the 12 cells 10A to 10L are separated from each other which will be discussed in more detail below. It will be appreciated by a person skilled in the art that other electrolysis cell plate numbers and combinations may be used.

In the system in accordance with the invention, the electrolysis cell plates 80 may be fabricated from a variety of materials such as stainless steel, titanium, nickel, graphite based materials, mild steel or other carbon steel alloys. In use, the electrolysis cell plates 80 are at least partially immersed in the electrolyte solution providing a means for electrolysis to occur.

The use of multiple cells (i.e. 12 in this embodiment) provides a means for keeping the overall operational voltage of the electrolysis tube 1500 within the proximity of 18-28 Volts being preferable for effective operation. In particular, the arrangement of cell plates into separate cells 10A-10L allows for optimizing the voltage across each cell to maintain current flow.

The different cells 10A-10L may comprise a different number of electrolysis cell plates. For example, as illustrated in FIG. 10, cells 10E, 10F and 10G that are proximal to the intermediate enclosure section 100M of the outer enclosure 100 comprise a smaller number of electrolysis cell plates compared to cells 10A, 10B, 10K and 10L proximal to either of the first end 100A or the second end 100B of the outer enclosure 100.

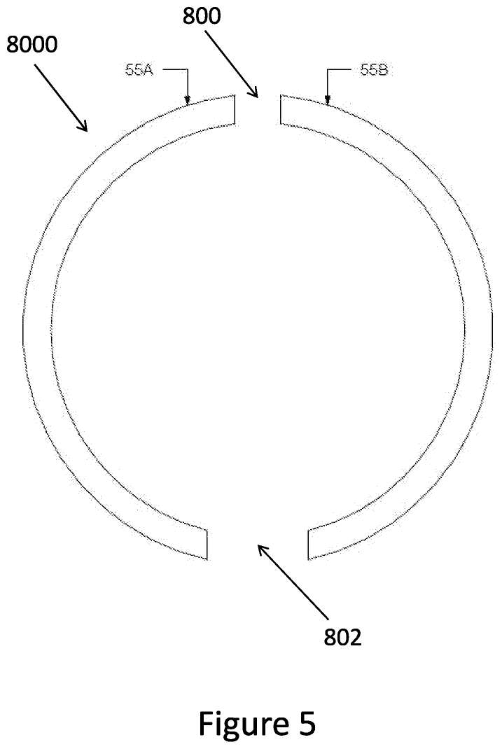

In addition to the outer enclosure 100, the electrolysis tube 1500, in accordance with an embodiment of the invention, also includes at least one electrolysis cell plate enclosure 8000 as is shown in FIGS. 5, 6, 7 and 8. The electrolysis cell plate enclosure 8000 is located intermediate the outer enclosure 100 and the electrolysis cell plates 80 of each cell and is adapted to separate each of the 12 cells from each other in the embodiment shown.

Each of the 12 cells 10-10L include a like cell plate enclosure 8000. This cell plate enclosure 8000 acts to concentrate electrolyte ions in close proximity to the plurality of electrolysis cell plates 80 in use, allowing each of the plurality of electrolysis cell plates 80 to maintain their voltage in operation. Furthermore, the cell plate enclosure 8000 is adapted to prevent ionic migration from cell to cell, thus maintaining individual cell voltage.

The cell plate enclosure 8000 allows for a compact cell structure avoiding the need to have discrete cells connected together in separate units.

In the embodiment shown in FIGS. 5 to 8, the cell plate enclosure 8000 includes a pair of enclosure elements 55A, 55B that are half-cylindrical in shape having a substantially semicircular cross section, as shown in FIG. 5. The pair of enclosure elements 55A, 55B are adapted to wrap circumferentially around the electrolysis cell plates 80 thereby partially enclosing them. In the embodiment shown, the enclosure elements 55A, 55B mutually oppose each other and are separated by an upper channel 800 and a lower channel 802 which, in the embodiment shown, extend along the length of the electrolysis cells 80. The upper channel 800 is adapted to allow for the passage of electrolysis gas whereas the lower channel 802 allows for the passage of electrolyte.

As can be seen in the cross-sectional view of FIG. 8, the intermediate location of cell plate enclosure 8000 between outer enclosure 100 and electrolysis cell plates 80 define a radial outer gap 202 between the outer enclosure 100 and the cell plate enclosure 8000 to prevent electrical shorting between adjacent cells as will be discussed below.

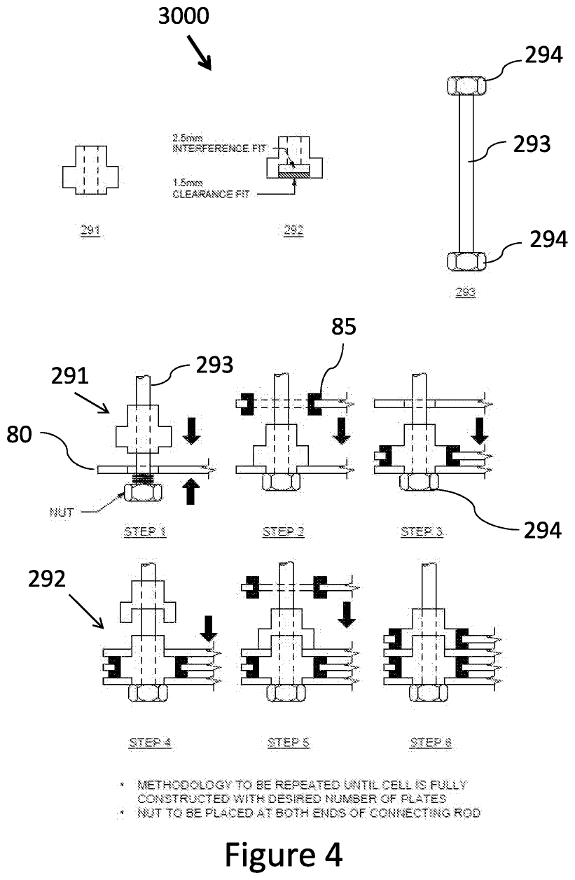

With reference to FIG. 8, the enclosure elements 55A, 55B are disposed within the electrolysis tube 1500, providing a gap 202 as is exemplified in FIGS. 2 and 4 between the electrolysis cell plates 80 and the outer enclosure 100 (also referred to as cylinder enclosure). This gap 202 prevents shorting of the electrolysis cell plates 80 with the outer enclosure 100.

In the embodiment shown in the Figures, each of the electrolysis cell plates 80 are disk-shaped with the cell plate enclosure elements 55A, 55B having a substantially semi-circular cross section to encircle the disk-shaped electrolysis cell plates 80. It will be understood by a person skilled in the art, that the shape of the cell plate enclosure elements 55A, 55B will be largely dictated by the shape of the electrolysis cell plates 80.

Within each of the cells 10A-10L, the cell plates 80 form electrolysis regions in which electrolysis of an electrolytic fluid occurs. The electrolysis regions are confined to within the cells 10A-10L defined by the cell plate enclosure elements 55a and 55B and termination plates 260 and 280.

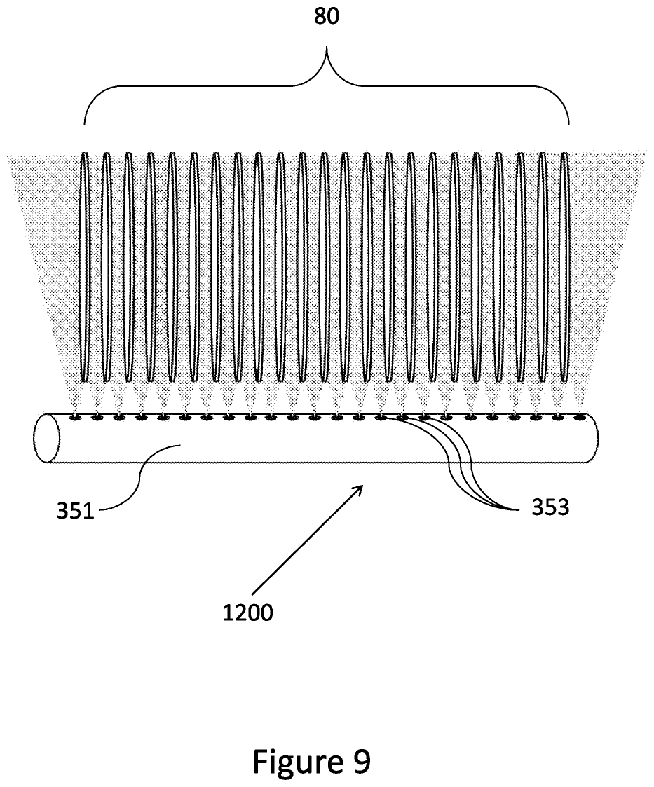

As is exemplified in FIG. 9, the electrolysis tube 1500 includes an electrolyte injection system 1200 which includes at least one electrolyte injection tube 351 which includes a plurality of longitudinally disposed upwardly directed apertures. The plurality of apertures are adapted to dispense electrolytic fluid within the vicinity of the electrolysis cell plates 80 when in operation. In the embodiment shown in FIG. 9, the electrolyte injection tube 351 extend longitudinally along the length of the electrolysis tube 1500 and substantially perpendicular to the electrolysis cell plates 80.

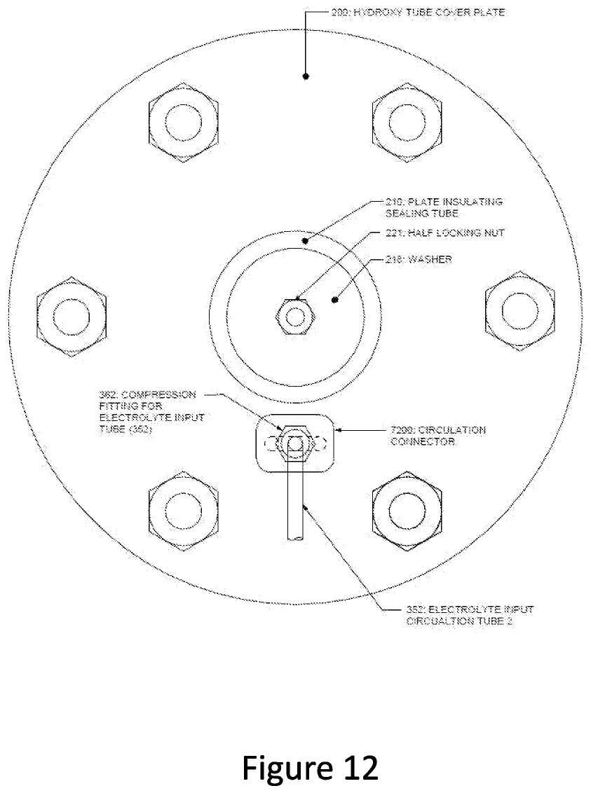

With reference to FIGS. 4 and 12, the injection tubes 351 are located below the electrolysis cell plates 80 in or adjacent the lower channel 802. The injection tubes 351 are adapted to direct the electrolyte solution upwardly from the apertures 353 resulting in the injection of electrolyte fluid onto the electrolysis cell plates 80. In some embodiments, the upwardly directed apertures 353 are about 1 mm in diameter. The electrolyte solution is typically supplied at a pressure of 70 KPa to provide enough pressure to inject the electrolyte solution onto the electrolysis cell plates 80 in sufficient quantity for effective operation.

Although two injection tubes are illustrated, in other embodiments, a single injection tube or three or more injection tubes may be used.

The injection tubes 351 may be fabricated from a variety of non-metallic materials, it is envisaged that it would be fabricated from a polymer such as polypropylene or PTFE (TEFLON®). Polymers are selected for ease of manufacturing and to minimise costs. Furthermore, polymers such as PTFE may be easily moulded or cut into an appropriate shape aiding in the ease of manufacture.

As is shown in FIG. 10, either or each end of the electrolysis tube 1500 includes a gas outlet 102 which allows the electrolysis gas to exit the electrolysis tube 1500 for use.

The gas outlet 102 may take a number of gas tight fittings allowing for the connection to piping within the system exemplified in FIG. 10.

With reference to FIG. 11, an electrical voltage in the proximity of 18-28 Volts is supplied though the eye bolt 222 which is positioned within the electrolysis tube cover plate 200 and electrically connected to the shroud termination plate 270. The voltage is then transmitted through the steel terminal 250 which as previously mentioned, is electrically connected to the shroud termination plate 270. Voltage is then fed to every second electrolysis cell plate 80, providing an alternation of voltages between subsequent electrolysis cell plates 80.

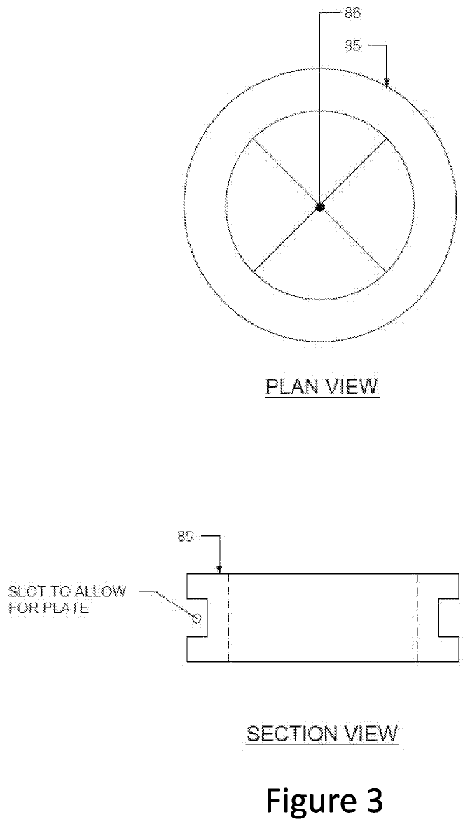

This is achieved by having every second electrolysis cell plate 80 electrically insulated from adjacent electrolysis cell plates 80. As will be described in more detail below and with reference to FIGS. 8 and 3, an insulating element 85 is placed within the apertures of the electrolysis cell plates 80 allowing them to be electrically insulated from the voltage supply.

In operation, the electrolysis tube 1500 is powered using a AC to DC power supply 1560 as is shown in FIG. 1, the output of the AC to DC power supply 1560 is then input into a DC polarity oscillator 505 after which the output is fed into an electronic control module 506, which is adapted to output an appropriate voltage which in the case of the electrolysis tube is preferably around 18-28 Volts.

With the voltage applied to the electrolysis cell plates 80 and the electrolysis tube 1500 at least partially filled with electrolyte, the electrolysis process occurs. In the electrolysis process the voltages applied to the electrolysis cell plates 80 creates an electric field between adjacent plates (due to the different polarity) between the adjacent electrolysis cell plates 80, causing currents to flow through the electrolyte and initiating the process of electrolysis. Through the process of electrolysis, electrolysis gasses such as hydroxy gas (HHO) are created due to the electrolysis reaction and the gasses then rise to the top of the electrolysis tube 1500 where they are captured and extracted at the gas outlets 102.

During the electrolysis process, the injection tubes 351 are supplied with pressurized electrolyte which is upwardly sprayed onto the electrolysis cell plates 80. This is typically achieved at pressures of around 70 KPa as was previously discussed.

With reference to FIG. 7, the upper channel 800 allows for the flow of the electrolyte gas between adjacent cells within the electrolysis tube 1500. The lower channel 802 allows for the circulation of the electrolyte fluid throughout the electrolysis tube 1500.

System Overview

An embodiment of a system for generating an electrolysis gas is generally indicated by 2000 in FIG. 1. The system includes the electrolysis tube 1500 as was previously described.

In the system for generating the electrolysis gas 2000, there is included at least one electrical input power source 240, which may be a 240 V or 110 V power supply or similar which in the embodiment shown feeds an AC to DC power supply 1560, the output of which is fed into a DC polarity oscillator 505. The DC polarity oscillator 505 is adapted to change the voltage polarity at predetermined time intervals. The output of the DC polarity oscillator 505 is then fed into an electronic control module 506 which among other things controls the voltage input to the electrolysis tube (shown as 1500 in FIG. 10).

As previously mentioned, the voltage input into the electrolysis tube 1500 is adapted to change polarity with the combination of the DC polarity oscillator 505 and the electronic control 506. The electronic control 506 feeds the alternating voltage to the electrolysis cell plates 80 resulting in a periodic change in polarity which results in minimising cathodic erosion on the electrolysis cell plates 80.

The system for generating the electrolysis gas 2000 is designed to use a specific electrolyte solution which the inventor has found to reduce erosion of the electrolysis cell plates 80. Preferably, the electrolyte solution includes 15% wt potassium hydroxide with trace amounts of sodium.

In other embodiments, the system may utilise an electrolyte solution including 15% wt potassium hydroxide with trace amounts of sodium.

The use of the aforementioned solutions have been observed by the inventor to at least reduce the electrolysis cell plate 80 erosion, in combination with the alternation of plate electrical polarity as was previously discussed, increasing the life of the electrolysis cell plates 80. The combination of the aforementioned electrolytes has been shown to form a hydride on the electrolysis cell plates 80 further reducing electrolysis cell plate 80 erosion.

As can be seen in FIG. 1, the system for generating the electrolysis gas 2000, includes a reverse osmosis (RO) water input reservoir 1550 which feeds the system 2000 with filtered water. The filtered water is then circulated around the system with the aid of a pump 7000, which in the embodiment shown is a magnetic drive pump.

A liquid level sensor 512 is used to monitor the electrolyte level where if the electrolyte levels drop, the magnetic drive pump is used to increase the level of electrolyte in the system thus maintaining the electrolyte levels in relation to the electrolysis cell plates 80.

The filtered water is pumped into hydroxy liquid tower 501 which is required to maintain the electrolyte level in the system 2000. The hydroxy liquid tower 501 is adapted to ensure that the electrolysis cell plates 80 are partially immersed to maintain their efficiency.

The hydroxy liquid tower 501 further includes gas condensation baffles 511 which are required to condensate any vapour that may be present within the hydroxy gas. Situated at the top of the hydroxy liquid tower 501 is an electronic pressure relief valve 514 which is adapted to release any pressure which may build up within the system.

A cock valve 513 is situated between the hydroxy liquid tower 501 and a hydroxy gas tower scrubber 502 and is adapted to terminate gas flow from the hydroxy gas tower scrubber 502 to the hydroxy liquid tower 501. The hydroxy gas tower scrubber 502 is required to condense (scrub) the hydroxy gas to remove any liquid from the hydroxy gas via gas condensation baffles 511, thereby removing any condensation from the hydroxy gas.

The output of the hydroxy gas tower scrubber 502 is then passed into an electronic back flash arrestor and gas purifier 503. The electronic back flash arrestor and gas purifier 503 quenches the burning of the hydroxy flame output at the output nozzle 504. It also aids in purifying the output hydroxy gases.

The inventor has noted that when the gas output nozzle 504 releases the gas, and when detonated in the atmosphere, it produces an exothermic reaction and expands rapidly. In contrast, if the gas is detonated in a closed container, it expands and contracts at the same time at around 0.06 second, causing a net implosion.

Method of Cell Manufacture and Assembly

With reference to FIG. 4, a method for assembling an electrolysis cell plate arrangement for a system generating an electrolysis gas is generally indicated by 3000. The method of assembling the electrolysis cell units is exemplified in FIG. 4 and described below.

With reference to FIG. 2 it can be seen that the electrolysis cell plates 80 which are used in the electrolysis tube 1500 are circular in shape and comprise a plurality of apertures 301A, 301B which in the embodiment shown, are circular.

As can be seen in FIG. 2, the apertures comprise two different diameters with one being larger 301A than the other 301B. The larger apertures 301A are adapted to receive an insulating element 85 and the smaller apertures 301B a conducting spacer element (not shown). The insulating element 85 is shown in FIG. 3, which in this embodiment is an insulating resilient gromet which may be manufactured from a variety of flexible dielectric materials such as polypropylene, PTFE (TEFLON®), synthetic rubber or silicone as a few examples. The insulating element 85 is press fit into the larger apertures 301A of the electrolysis cell plates 80. The insulating elements 85 comprise a channel as shown in the section view of FIG. 3. The channel being adapted to snugly fit into the larger aperture of the electrolysis cell plates 80. The electrolysis cell plates would typically be provided with the insulating elements 85 inserted.

Slide the second electrolysis cell plate onto the support rod such that the insulating collar engages the first conducting spacer element and first electrolysis cell plate.

With reference to FIG. 4, the method for constructing each cell (of which there are 12 cells in this embodiment) of the electrolysis tube 1500 may comprise the steps of:
1. Supply a first fastening device such as nut 294 onto one end of the support member 293;
2. Slide a termination cell plate 260 or 280 onto the support member 293;
3. Slide a conducting spacer element 291 onto the support member 293;
4. Slide an electrolysis cell plate 80 with an electrically insulated grommet 85 fitted to the large aperture onto the support member 293 continuing onto the conducting spacer element 291;
5. Slide an electrolysis cell plate 80 onto the support member 293 and onto the conducting spacer element 291;
6. Slide a conducting spacer element 292 to the support member 293 to engage conducting spacer element 291;
7. Slide an electrolysis cell plate 80 with an electrically insulated grommet 85 fitted to the large aperture onto the support member 293 continuing onto the conducting spacer element 292;
8. Slide an electrolysis cell plate 80 onto the support member 293 continuing onto the conducting spacer element 292;
9. Repeat steps 6 to 8 until the desired number of electrolysis cell plates is achieved;
10. Slide a termination cell plate 260 or 280 onto the support member 293;
11. Introduce longitudinal pressure to snug all conducting spacer element joins in the electrolysis cell assembly;
12. Screw a second fastening device such as nut 294 onto one end of the support member 293.

It is envisaged that the conducting spacer elements 291 and 292 may be press fit into the plurality of apertures in each electrolysis cell plate 80. In this case to ensure a tight fit, the internal diameter of the plurality of apertures would be approximately equal to the external diameter of the conducting spacer elements 291. In some embodiments, a longitudinal compressional force is applied to the electrolysis cell plates of a cell during the above process to provide a snug fit between conducting spacer elements.

With reference to FIG. 4, a support member 293 is used to ensure the conducting spacer elements 291 and 292 are prevented from separating in use. In the embodiment shown, the support member 293 takes the form of a bolt, which is threaded through an aperture in the conducting spacer elements 291 and 292.

Support member 293 includes screw threads at respective opposing ends and a nut 294 is provided for each end of the support member 293 to securely attach the conducting spacer elements 291 and 292 together.

Each of the conducting spacer elements 291 and 292 are adapted to allow for the insertion of the support member through each of the conducting spacer elements 291 and 292. In the embodiment shown, this is achieved by an aperture longitudinally through each of the conducting spacer elements 291 and 292 with a diameter slightly larger than the outside diameter of the support member 293 to allow for insertion of the support member 293 into each of the conducting spacer element 291 and 292.

Hydrogen Generation and Storage

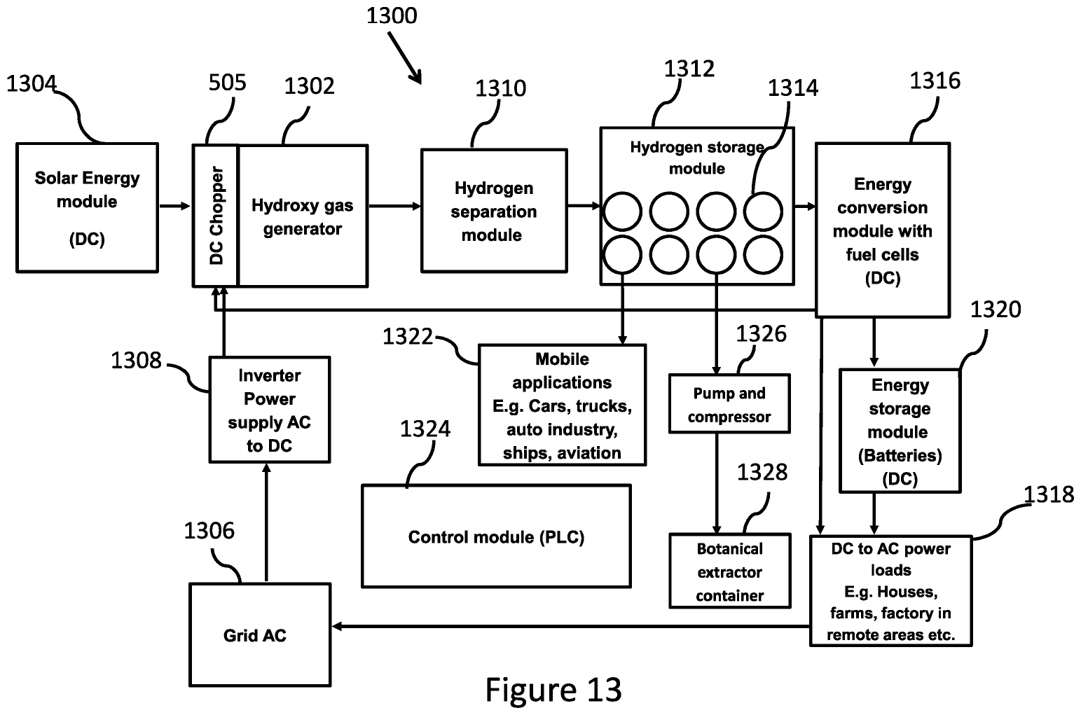

Referring now to FIG. 13, there is illustrated a system 1300 for generating and storing hydrogen for use in products like fuel cells.

Central to system 1300 is an electrolysis gas generation module 1302 for generating an electrolysis gas such as hydroxy gas. Module 1302 preferably comprises electrolysis gas generation system 2000 as described above that is configured to generate hydroxy gas, which can subsequently be converted to hydrogen. Module 1302 may be powered by a green energy source such as a solar energy module 1304 or Module 1302 may be powered by blue energy source such electricity from an AC power grid 1306 supplied to an AC to DC power supply 1308. By way of example, electricity from an AC power grid 1306 may provide a 240 Volt AC supply that is directed to multiple hydroxy gas generation modules 1302, each consuming 3.6 kWh. This power is delivered via an AC to DC power supply 1308, which rectifies an AC signal to a DC signal and subsequently to a DC polarity oscillator 505 for powering module 1302. Module 1302 may be powered by one or both of solar energy module 1304 and AC grid 1306. Furthermore, these power sources may be used to power other modules and elements of system 1300 described below.

The AC to DC power supply 1308 may rectify a 240 Volt or 110 Volt AC power signal to a DC signal around 18-28 Volts and 115 Amps. In other embodiments, AC to DC power supply 1308 may be configured to output other signals having higher or lower combinations of amps and voltages.

Solar energy module 1304 may represent or include commercially available photovoltaic systems that are configured to generate DC power from sunlight. By way of example, solar energy module 1304 may be a typical rooftop solar module installed on residential and commercial properties or large-scale industrial sites like solar farms. Solar energy module 1304 generates green electrical energy that may be transformed or converted into an appropriate power signal for direct operation of electrolysis gas generator modules 1302.

As described above, module 1302 is configured to perform electrolysis to generate an electrolysis gas such as hydroxy gas as an output. This hydroxy gas is transmitted to a hydrogen separation module 1310. Module 1310 preferably performs separation of H₂ and O₂ using a separation membrane such as a metallic membrane (e.g. palladium or palladium-silver alloys) and a pump to pass the gas through the membrane in a conventional manner known in the art. Separation module 1310 receives the hydroxy gas from module 1302 which has hydroxy gas and other gases mixed therein, as specified by industry accepted gas measuring instruments. In some embodiments, hydroxy gas generator module 1302 produces an output that has the following composition: 66.3% Hydrogen, 31.5% Oxygen, other gases and around 1.59% vapour. The separated oxygen may be vented to the atmosphere or separately contained and sold as a by-product.

Module 1310 outputs pure, clean hydrogen gas (H₂) at a temperature preferably in the range of 30 degrees Celsius and 100 degrees Celsius and a pressure preferably in the range of 0 PSI to 30 PSI (0 KPa to ˜207 KPa). more generally, the pressure of the hydrogen gas output from module 1310 may be lower than 690 KPa. The output hydrogen gas is pumped, via a pump (not shown) and conduit (also not shown), to a hydrogen storage module 1312. This hydrogen storage module 1312 includes one or more dedicated storage canisters 1314 and the separated hydrogen gas from module 1310 is pumped into these storage canisters 1314 using standardised safety standards in storing hydrogen. The hydrogen gas is preferably pumped into storage module 1312 at an input temperature preferably in the range of 30 degrees Celsius and 100 degrees Celsius and an input pressure preferably in the range of 0 PSI to 30 PSI (0 KPa to ˜207 KPa). However, in some embodiments, the hydrogen gas is pumped into storage module 1312 at a pressure up to and including 690 KPa.

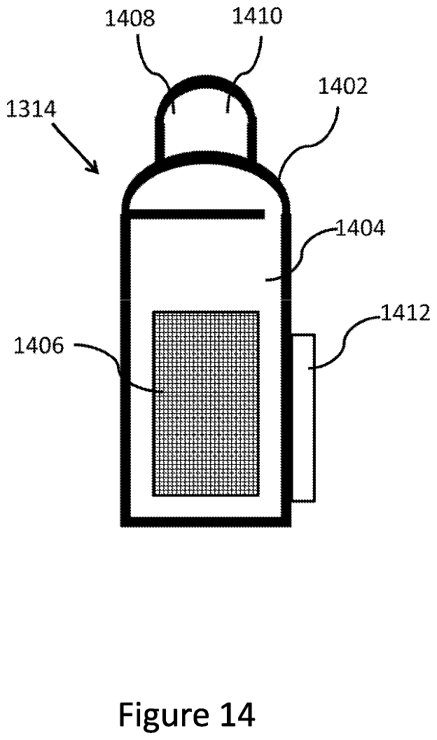

As shown in FIG. 14, the storage canisters 1314 within storage module 1312 are partially filled with a hydrogen storage compound 1406 which bonds with hydrogen gas H₂. The hydrogen storage compounds include compounds such as Titanium carbide (TiC) powder, Titanium hydride (TiH₂), Magnesium hydride (MgH₂), Titanium hydrocarbons such as TiCH₂, multilayered Ti₂CTₓ [T is a functional group] compounds, other metal hydrides or microporous hydrogen storage materials for safe hydrogen chemical storage within the canister 1314. The canisters 1314 within module 1312 are removable from module 1312, mobile and transportable in a manner similar to that of liquid petroleum gas (LPG) bottles.

Storage module 1312 may also include processing elements that facilitate the filling and distribution of hydrogen gas to the storage canisters 1314. In some embodiments, the storage canisters 1314 are maintained in a rack or mount to form a one or two dimensional array of canisters 1314 within module 1312. These canisters 1314 containing H₂ stored in the hydrogen storage compound, can be moved out of this array safely and placed into cars, trucks, buses, motorbikes, harvesters, tractors or other larger vehicles used in aviation or shipping, to utilise the generated green fuel within the canister which also contains the nominated hydrogen storage compounds. The canisters 1314 within module 1312 may also remain stationary and provide a safe chemical hydrogen storage system for small scale applications like households, or large scale applications like factories or farms, or transportation vehicles by safely filling fuel cells from the hydrogen canisters.

Although not shown, storage module 1312 includes a system of gas delivery conduits, valves and regulators for selectively delivering the hydrogen gas to the canisters 1314. In some embodiments, storage module 1312 operates in a similar manner to that of an LPG) storage system.

The canisters 1314 are capable of storing hydrogen at pressures significantly lower than the current accepted 10,000 PSI (˜69,000 KPa) used in the automobile industry. In some embodiments, the canister design supports an internal temperature of less than or equal to around 100 degrees Celsius to facilitate and maintain the hydrogen bonding with the hydrogen storage compound. However other designs with other chemicals used as the hydrogen storage compound may have a variation on temperature and pressure. The input pressure of the canisters 1314 may be less than or equal to around 690 KPa and around 50 degrees Celsius. The output pressure for the canisters 1314 may be around 30 PSI (˜207 KPa) and around 95 degrees Celsius. However, pressures higher than these may be implemented in certain embodiments.

In some embodiments, hydrogen gas may be pumped from the canisters 1314 via a pump 1326 and compressed by a compressor to a pressure of around 2000 PSI (˜13,790 KPa). This compressed hydrogen gas can be input to a botanical extractor container 1328 containing a botanical compound such as hemp. The mixing of the hydrogen gas with the botanical compound produces by-products such as oils, perfumes and the like which are suitable for the pharmaceutical and cosmetic industries.

Referring to FIG. 14, in some embodiments, the canisters 1314 are formed of stainless steel outer protective housing 1402, have a diameter of around 200 cm and a length of around 300 cm. The protective housing 1402 defines an internal sealed storage chamber 1404 that, in some embodiments, has a total internal area of 9,429 cm³. The hydrogen storage compound 1406 described above is contained within the sealed storage chamber. The canisters 1314 may house approximately 3.846 kg of hydrogen and have a total weight of around 47 kg. The above described canister design can provide for up to 152 kWh of energy and a potential vehicle driving range of around 500 km for a 1 tonne car. In other embodiments, the canisters 1314 are formed, at least in part, of Teflon (PTFE), Kevlar or other synthetic fibres or polymers to maintain strength as well as durability and weight minimisation.

Canisters 1314 include an inlet port 1408 for selectively allowing ingress of hydrogen gas to the storage chamber 1404. The hydrogen gas is input to canister 1314 in a controlled manner using gas regulators and/or valves. Canisters 1314 also include an outlet port 1410 for selectively allowing egress of hydrogen gas from the storage chamber in a controlled manner. In some embodiments, inlet port 1408 and outlet port 1410 share the same aperture and ingress and egress of hydrogen gas is controlled by a valve and regulator assembly. Preferably, inlet port 1408 and outlet port 1410 are formed of stainless steel to withstand exposure to hydrogen gas.

To release hydrogen gas from the hydrogen storage compound, the temperature of the internal storage chamber 1404 is raised to 100 degrees Celsius or more. To achieve this, in some embodiments, canisters 1314 also include a heating element 1412 configured to selectively heat a temperature of the storage chamber 1404 to release hydrogen gas from the hydrogen storage compound 1406. By way of example, this heating element 1412 may include an electrothermal jacket that can be wrapped around protective housing 1402 of canisters 1314. In some embodiments, this electrothermal jacket includes an electrically controllable heating device. In other embodiments, heating element 1412 includes or is connected to a heating system that redirects excess heat from a fuel cell system described below or an electrolysis system described above to protective housing 1402. By way of example, heat may be piped from the fuel cell system or electrolysis system using one or more conduits to a thermally conductive jacket disposed around protective housing 1402 to heat the canister.

Although illustrated as a generally cylindrical canister, it will be appreciated that canisters 1314 may be formed in a number of other shapes and sizes depending on the location and applications of use (e.g., whether they are used for stationary or mobile applications, or small or large scale applications).

The hydrogen stored in canisters 1314 of module 1312 support the generation of electrical energy via fuel cells by utilising the stored hydrogen that is contained in canisters 1314. Canisters 1314 may be connectable with one or more fuel cells of an energy converter module 1316 via connection through outlet port 1410, as shown in FIG. 13. The canisters 1314 are selectively heated to release the hydrogen gas from the hydrogen storage compound and passed out of the outlet to the connected fuel cell. The fuel cells of converter module 1316 receive the input hydrogen gas from module 1312 and convert it to electrical energy through reduction oxidation reactions with an oxidising agent such as oxygen in a known manner. The generated electricity may be used for powering loads 1318 such as electric vehicles, households, factories, large industrial structures and buildings. The generated electricity may also be redirected back to the original hydroxy generator module 1302 as a DC current source to power further hydroxy and hydrogen gas generation. As illustrated by the arrow in FIG. 13, excess electricity may be redirected back to AC grid 1306 when there is an excess generated.

Electricity generated by the energy conversion module 1316 may be passed to an energy storage module 1320. Energy storage module 1320 includes one or more DC batteries for storing electrical energy and optionally an inverter for converting the stored DC energy into AC power. The AC power may be supplied back into the grid and/or used to power AC power loads 1318.

The canisters 1314 of storage module 1312 may be removed and used for mobile applications 1322 such as in cars, trucks, buses, aviation vehicles, and shipping. In some embodiments, storage module 1312 itself is mobile and may be transported on vehicles carrying multiple canisters 1314. This provides a safe storage of hydrogen fuel to operate fuel cells powering the vehicles such as cars. In some embodiments, a new fuel cell design may be used which is adapted to receive or connect with one or more canisters 1314. In other embodiments, the vehicle or fuel cell may provide for retrofitting one or more canisters 1314 to the vehicle for use with the fuel cell(s).

A control module 1324 is provided for automating, controlling and monitoring the entire system 1300 according to one or more decision tables, artificial intelligence or rule-based engines. Control module 1324 includes one or more processors with associated memory and controls inputs and outputs, flow rates, temperatures and pressures and makes real time decisions on flows from all modules of system 1300 with established fall-back positions, to secure efficiency and safety and the integrity of the overall system 1300. Although not shown, a series of sensors may be disposed around system 1300 and the data from these sensors are fed to control module 1324 as inputs for performing control and monitoring. Control module 1324 may be responsible for controlling the source of heat to heating element 1412 described above. By way of example, control module 1324 may control when to heat canisters 1314 using an electric heating device or when to heat canisters 1314 using heat circulated from an electrolysis system or fuel cell system. Module 1324 may also provide remote monitoring and shutdown processes and maintenance engineering redundancy, for all modules and regular software updates.

The above described system 1300 for generating and storing hydrogen provides a safe, environmentally friendly and cost effective way of generating, storing and transporting hydrogen for use as a fuel in fuel cells or the like. Through the use of suitable hydrogen storage compounds within storage canisters, the hydrogen can be stored safely at pressures below 690 KPa and at temperatures below 100 degrees Celsius. The hydrogen storage canisters 1314 are able to be safely transported and used in portable applications such as vehicles. The low pressure and temperature storage means they pose a significantly lower safety risk in terms of combustibility and explosions than conventional hydrogen storage systems, which store hydrogen at or around 10,000 PSI (˜69,000 KPa).

System 1300 can be installed and run on a residential property that is powered by one or both of a conventional solar energy module 1304 installed on the property or by electricity from an AC power grid 1306. The hydrogen generated in system 1300 can be stored in canisters 1314 and transported for use in applications like cars.

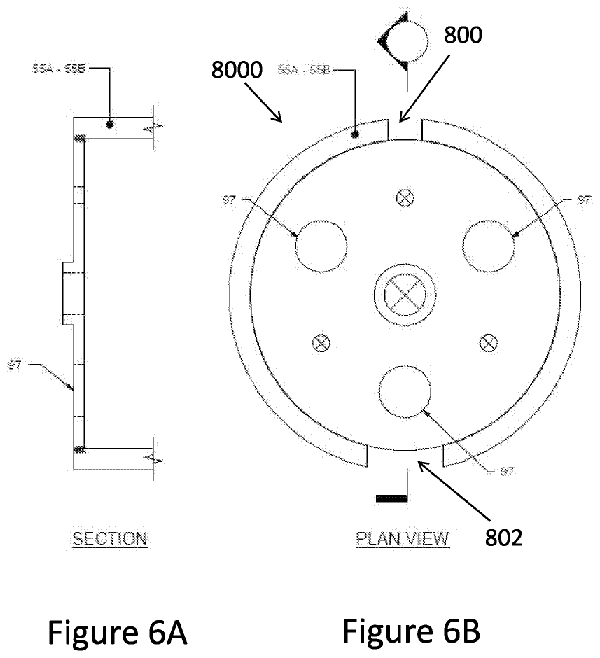

Component List
Electrical Power Input—Item 240 (FIG. 1), AC power supply from grid.
AC to DC Power Supply—Item 1560 (FIG. 1), customised electric power supply to drive the system and all its components.
DC Polarity Oscillator—Item 505 (FIG. 1), required to change the polarity from positive to negative. This will maintain the plating effect that will maintain reliability and longevity of the cells.
Electronic Control—Item 506 (FIG. 1), required to control the input DC which is required to monitor the liquid switch and liquid overflow sensor. The electronic control also controls the power input to item 1500 to produce and control the gas at the required pressure.
Pressure Switch—Item 507 (FIG. 1), required to monitor the pressure of the hydroxy gas within the system and sends a signal to the electronic control 506 that operates the input DC power to item 1500.
Liquid Overflow Sensor—Item 508 (FIG. 1), required to monitor the level of the liquid that has been condensed by the baffles within the hydroxy gas powered scrubber 502. This overflow liquid is redirected back to the hydroxy liquid scrubber via an electronic cock valve and pressure release valve. This allows the pressure in the scrubber 502 to push the overflow liquid into the hydroxy liquid scrubber 501.
Hydroxy Electrolyte Heat Exchanger—Item 509 (FIG. 1), required to maintain the desired temperature of 70 degrees Celsius of the electrolyte in item 1500 to improve efficiency and control the temperature to the desired level.
Filtering System—Item 510 (FIG. 1), required to filter out the ferrite and the carbon given off by the slow denigration of the cell electrodes to maintain the purity of the electrolyte.
Electrolytic Liquid—Item 405 (FIG. 1), this is 15% caustic soda, 84% of distilled or reversed osmosis water and 1% reliability compound.
Water Reservoir—Item 1550 (FIG. 1), reverse osmosis water supply.
Magnetic Drive Pump—Item 7000 (FIG. 1), required to circulate the filtered electrolyte into the electrolysis tube.
Liquid Level Sensor—Item 512 (FIG. 1), required to monitor the electrolyte level so that the cells are partially immersed. If the liquid levels drop, the magnetic drive is operated via the electronic control and RO water is pushed into the hydroxy liquid tower 501.
Gas Condensation Baffles—Item 511 (FIG. 1), required to condense any vapour that may be present within the hydroxy gas.
Electronic Pressure Relief Valve—Item 514 (FIG. 1), required to release the pressure from the hydroxy liquid scrubber thereby allowing the liquid in the hydroxy gas powered scrubber to be diverted back the hydroxy liquid scrubber.
Electronic Cock Valve—Item 513 (FIG. 1), required to shut down the gas flow from the hydroxy liquid scrubber.
Hydroxy Gas Powered Scrubber—Item 502 (FIG. 1), required to scrub or condense the hydroxy gas to remove any liquid vapour from the hydroxy gas via the baffles.
Electronic Back Flash Arrestor and Gas Purifier—Item 503 (FIG. 1), required to quench and shutdown the burning of the hydroxy flame output at the nozzle. 503 is also required to purify the output hydroxy gasses.
Hydroxy Gas Output Nozzle—Item 504 (FIG. 1), required to output and combust the gas. The input pressures to the nozzle are 250 kPa (or ˜37 PSI). Refer to item 430 for description of hydroxy gas.
Hydroxy Gas—Item 430 (FIG. 1), which is stoichiometric HHO, that includes hydrogen and oxygen in an approximately two-to-one ratio with some minute impurities such us N2, HO2 vapor, N2O, Nitric acid.
Electrolysis Cell Plates—Item 80 (FIGS. 2, 4, 7, 8, 9, 10 & 11), these plates are made of stainless steel, titanium, nickel, graphite based materials, mild steel or other carbon steel alloys. There are between 18-36 plates per electrolysis cell unit. There are 12 cell units per electrolysis tube. Each cell plate has six apertures. The apertures alternate—one large aperture and one small aperture. These plates are the anode and cathode electrodes that generate the hydroxy gas within the electrolysis tube. These plates are electrically configured to have alternating polarities +ve|−ve|+ve|−ve and so on from one end of the electrolysis tube to the other. In this embodiment 12 cell units each of 36 plates are being illustrated (36×12 =432 plates). In other embodiments a variation of plates per cell unit will be utilised. In other embodiments the plate shape may not be circular but square, rectangular, hexagon, octagon or decagon. (Dimensions: thickness is 3 mm the Diameter 83 mm).
Cell Plate Aperture (Large)—Items 301A (FIG. 2), larger diameter apertures for housing the insulating elements.
Cell Plate Aperture (Small)—Items 301B (FIG. 2), small diameter apertures for receiving the Support Member.
Insulating Element Aperture—Item 86 (FIGS. 3 & 8), the hole in the insulating element for housing a support member.
Insulating Element—Item 85 (FIGS. 3 & 8), made of polypropylene and utilised to electrically insulate each electrolysis cell plate within the cell unit design.
Support Member——Item 293 (FIGS. 4 & 8), inserted through each cell plate and secured at the ends of the cell unit.
Conducting Spacer Elements—Item 291 (FIG. 4), constructed of metal and used in the assembly of each electrolysis cell unit.
Intermediate Conducting Spacer Element—Item 292 (FIGS. 4 & 7), constructed of metal with a hollow section containing 1.5 mm of clearance fit and 2.5 mm of interference fit, for the construction of electrolysis cell units.
Cell Plate Enclosure—Item 8000 (FIG. 5, 6A & 8), which comprises of 55A and 55B.
Enclosure Elements—Items 55A-55B (FIG. 5, 6A, 7 & 8), a shroud consisting of two steel mirrored halves, both of which are welded to each electrolysis cell unit. These elements enclose each of the 12 cell units and therefore 12 elements enclose sets are utilised. Required to seal the ions within the cell.
Upper Channel—Item 800 (FIG. 5, 6A & 8), a space for the electrolysis gas to migrate to the gas outlet to exit the system.
Lower Channel—Item 802 (FIG. 5, 6A & 8), a space for the electrolyte input circulation tube.
Termination Insulating Cap—Item 97 (FIG. 6A), this is required to insulate the terminal for each electrolysis cell unit. Three termination caps are required for each termination plate unit and therefore you require six termination caps for each cell unit, pressed fit. (Dimensions: 11 mm diameter, length 4 mm inside).
Interconnecting Spacers—Item 300 (FIGS. 7 & 10), made by polypropylene, total in number 11 placed between each electrolysis cell unit. (Dimensions: thinness 15 mm, diameter 111 cm, middle aperture 15 mm, outer apertures, two at each side 0.5 mm each).
Shroud Termination Cell Plate—Item 260 (FIGS. 7 & 10), each electrolysis cell unit is fitted with a shroud termination cell plate.
Termination Cell Plate (no shroud)—Item 280 (FIGS. 7 & 10), each electrolysis cell unit is fitted with a termination cell plate.
Electrolyte Injection System—Item 1200 (FIG. 9), required to deliver the electrolyte to the cell units.
Electrolyte Injection Tube—Item 351 (FIGS. 9, 7 & 8), made of Teflon (Dimensions: 1.6 meters long, 5 mm diameter) One, two or three tubes extending the entire length (or substantially the whole length) of the electrolytic tube and used to spray the electrolytic liquid, via the 1 mm apertures in the Teflon tube.
Electrolyte Injection Apertures—Item 353 (FIG. 9), apertures for injection of electrolyte fluid onto the electrolysis cell plates.
Electrolysis Tube—Item 1500 (FIGS. 10 & 8), the steel cylinder enclosure where the electrolysis gas is created.
Outer Enclosure—Item 100 (FIGS. 10, 7 & 8), this is a steel cylinder enclosure that houses the Hydroxy cell combined configuration units and all the components of the electrolysis tube. The terminating flange is welded to the end of this tube. (Dimensions: 140 mm D, 2.32 meters Length).
First End—Item 100A (FIG. 10), a reference point to one end of the electrolysis tube.
Second End—Item 100B (FIG. 10), a reference point to one end of the electrolysis tube.
Intermediate Section—Item 100M (FIG. 10), the middle section of the electrolysis tube.
Electrolysis Cell Units—Items 10A to 10L (FIG. 10), spaced longitudinally within the electrolysis tube.
Gas Outlet—Item 102 (FIG. 10), this is the outlet where the electrolysis gas referred to as hydroxy gas exits the electrolysis tube.
Flange Plate—Item 400 (FIG. 11), made of steel. Required to compress the termination gasket 350 between the Flange plate and electrolysis tube cover plate 200. The flange plate is fastened to the electrolysis tube cover plate with 6 bolts.
Termination Gasket—Item 350 (FIG. 11), This is made of synthetic rubber inert to toxic soda. (Dimensions: thickness 3 mm diameter: two termination gaskets are required per electrolysis tube).
Shroud Termination Cell Plate with Terminal—Item 270 (FIG. 11), each end of the electrolysis tube is fitted with a shroud termination cell plate with terminal. A steel terminal, item 250 is welded onto the shroud termination cell plate. (dimensions: 83 mm, thickness 3 mm).
Plate Insulating Sealing Tube—Item 210 (FIGS. 11 & 12), this is required to insulate the housing from the terminal using polymers spacers and Teflon packing with fire chock to prevent any leaking of electrolyte. (Dimensions 40 mm diameter, length 100 mm).
Terminal—Item 250, made of steel. This is connected to the end of each cylinder enclosure.
Packing and Fire Check—Item 215 (FIG. 11), packing made of Teflon. Required for insulation of the plate insulating tube.
Hard Spacer—Item 216 (FIG. 11), made of Polypropylene. Required to compress the Teflon packing and fire chalk 215 via tightening of compression nut one 217 and washer 218.
Spring Washer—Item 219 (FIG. 11), required to stop any movement of eyebolt 222.
Half Locking Nut—Item 221 (FIGS. 11 & 12), required to lock the entire terminal shaft assembly together.
Compression Nut 2—Item 220 (FIG. 11), required to compress the spring washer onto the eye bolt.
Eye Bolt—Item 222 (FIG. 11), required to create a connection to the terminal.
Compression Nut 1—Item 217 (FIG. 11), refer to item 216 for description.
Washer—Item 218 (FIGS. 11 & 12), refer to item 216 for description.
Electrolyte Input Circulation Tube 2—Item 352 (FIGS. 11 & 12), made of Steel. It connects to the hydroxy electrolyte heat exchanger 509. The tube is used to output the electrolyte to the steel circulation connector 7200.
Compression Fitting 1—362 (FIGS. 11 & 12), required to connect the electrolyte input circulation tube 352 with the steel circulation connector 7200.
Circulation Connector—Item 7200 (FIGS. 11 & 12), this is a steel box that acts a central connection zone for the electrolyte injection tube and electrolyte input circulation tube 351 & 352. Having this external will reduce the amount of space needed to contain the tubes.
Compression Fitting 2—361 (FIG. 11), required to connect the electrolyte injection tube 351 with the steel circulation connector 7200.
Electrolysis Tube Cover Plate—Item 200 (FIGS. 11 & 12), this plate is required to terminate each end of the electrolysis tube. Two electrolysis tube cover plates are required per electrolysis tube. This is required to compress and seal the flange and the ionic insulation tube. This steel plate has six apertures in the perimeter each aperture is 12 mm. It has a middle aperture that is 40 mm. the middle aperture is required for the terminal, item 250 to come out. (Dimensions: thinness 40 mm, 250 mm diameter).
Insulation Tube—Item 50 (FIGS. 11, 7 & 8), made of lonic polymer required to prevent ionic migration between cells. (Dimensions: 2.322 meters Length, Diameter 112 mm).
Radial Outer Gap—Item 202 (FIGS. 11 & 8).
Electrolysis Cell Unit—Item 120 (FIG. 11), there are 12 electrolysis cell units and each cell unit has between 20-36 electrolysis cell plates which function as electrodes (anode or cathode) depending on the polarity assigned by the DC Polarity Oscillator.
System for Generating and Storing Hydrogen 1300 (FIG. 13)—A system for generating and storing hydrogen from an electrolysis gas generation module. The hydrogen is stored under relatively low pressure and low temperature to be stored and transported safely.
AC Power Grid Module 1306 (FIG. 13)—The conventional AC power grid or network for a region.
AC to DC Power Supply Module 1308 (FIG. 13)—A conventional rectifier to convert AC power to DC power.
Solar Energy Module 1304 (FIG. 13)—A conventional solar generation module such as a rooftop solar installation or an industrial scale application like a solar farm.
Electrolysis Gas Generation Module 1302 (FIG. 13)—A module for generating an electrolysis gas such as hydroxy gas. This module may comprise electrolysis gas generation system 2000.
Hydrogen Separation Module 1310 (FIG. 13)—A membrane-based hydrogen separation module for separating hydrogen gas from another gas such as hydroxy gas.
Hydrogen Storage Module 1312 (FIG. 13)—A module that includes one or more portable hydrogen storage canisters for storing hydrogen at low pressure and temperature within hydrogen storage compounds contained within the canisters.
Hydrogen Storage Canisters 1314 (FIG. 14)—Portable hydrogen storage containers configured for storing hydrogen at low pressure and temperature within hydrogen storage compounds contained within the canisters.
Energy Converter Module 1316 (FIG. 13)—A module including one or more fuel cells for converting the hydrogen to electrical energy through reduction oxidation reactions with an oxidising agent such as oxygen.
Energy Storage Module 1320 (FIG. 13)—A module including one or more batteries for storing the energy converted by the energy converter module 1314.
Electrical Loads Module 1318 (FIG. 13)—Conventional electrical loads such as houses, farms, factories and buildings.
Mobile Applications Module 1322 (FIG. 13)—Mobile powered devices such as cars, trucks, buses, aviation vehicles and ships, or other systems which have onboard fuel cell systems.
PLC Control Module 1324 (FIG. 13)—A control module for controlling the various modules and components of the system for generating and storing hydrogen 1300.
Inlet Port 1408 (FIG. 14)—An inlet in the hydrogen storage canisters for pumping hydrogen gas into the internal sealed storage chambers.
Outlet Port 1410 (FIG. 14)—An outlet in the hydrogen storage canisters for pumping hydrogen gas out of the internal sealed storage chambers. In some embodiments, the inlet and outlet ports may be one and the same port.
Protective Housing for Canisters 1402 (FIG. 14)—A protective housing formed of stainless steel or other protective material to house the stored hydrogen in a hydrogen storage compound.
Internal Sealed Storage Chamber 1404 (FIG. 14)—An internal chamber of the storage canisters defined by the protective housing. The storage chamber contains the hydrogen storage compound together with any stored hydrogen.
Heating Element 1412 (FIG. 14)—An electrically controlled heater or other heating device attached to or placed in close proximity to a hydrogen storage canister 1402 (such as a jacket) to heat the temperature within the internal sealed storage chamber 1404 to release hydrogen gas. This includes a thermoelectric heating element (jacket), and/or an excess heat recirculation system for returning excess heat generated from fuel cells and/or from an electrolysis system.
Hydrogen Storage Compound 1406 (FIG. 14)—A compound that is capable of bonding with hydrogen gas (H₂) to form a stable compound. Example hydrogen storage compounds include metal hydrides such as Titanium carbide (TiC) powder and Titanium hydride (TiH₂).

Interpretation

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skiled in the art will realise that additional embodiments can be readily envisioned that are within the scope of the present invention.

1. An electrolysis cell apparatus comprising:
an outer enclosure for containing an electrolyte solution, the outer enclosure having a first end, a second end and an intermediate enclosure section located between the first and second end;
a plurality of electrolysis cell plates forming at least one electrolysis region in which electrolysis occurs, housed within the outer enclosure and at least partially immersed in an electrolyte solution; and
a cell plate enclosure disposed within the outer enclosure that at least partially encloses the plurality of electrolysis cell plates, wherein the cell plate enclosure is adapted to concentrate electrolyte ions in close proximity to the plurality of electrolysis cell plates in use.

2. The electrolysis cell apparatus of claim 1, wherein the plurality of electrolysis cell plates are divided into cell plate sections between the first end and the second end, the cell plate sections being electrically connected in series.

3. The electrolysis cell apparatus of claim 2, wherein the cell plate sections proximal to the intermediate enclosure section comprise a different number of electrolysis cell plates compared to the cell plate sections proximal to either of the first end or the second end of the enclosure.

4. (canceled)

5. The electrolysis cell apparatus of claim 1, wherein a longitudinal compressional force is applied to the plurality of electrolysis cell plates to provide a snug fit between conducting spacer elements and the plurality of electrolysis cell plates forming at least one electrolysis region.

6. The electrolysis cell apparatus of claim 1, wherein the plurality of electrolysis cell plates are shaped to define a uniform gap between the cell plate enclosure and outer edges of the electrolysis cell plates.

7. The electrolysis cell apparatus of claim 5, wherein each electrolysis region includes a pair of enclosure elements, providing an upper channel and a lower channel extending along the length of each electrolysis region.

8. The electrolysis cell apparatus of claim 7, further includes one or more electrolyte injection devices which include a plurality of openings adapted to inject an electrolytic fluid within the lower channels of each electrolysis region.

9. The electrolysis cell apparatus of claim 8, wherein the one or more electrolyte injection devices is comprised of a dielectric material.

10. (canceled)

11. (canceled)

12. (canceled)

13. (canceled)

14. The electrolysis cell apparatus of claim 1, wherein the system further includes at least one electrical power source operatively connected to the at least one electrolysis region and adapted to alternate its electrical polarity.

15. The electrolysis cell apparatus of claim 1, wherein a compound is included within the electrolyte to promote the formation of a hydride on the electrolysis cell plates and/or electrolysis enclosures in use.

16. (canceled)

17. (canceled)

18. (canceled)

19. (canceled)

20. The electrolysis cell apparatus of claim 1, the further including electrolysis regions comprising a lower channel for accommodating an electrolytic fluid device to be housed along a lower region of the outer enclosure to an inlet.

21. A gas produced by the electrolysis cell apparatus according to claim 1.

22. A method for assembling an electrolysis region, the method comprising the following steps:
a. providing a support member with a first fastening device;
b. introducing a first termination cell plate to the support member;
c. introducing a conducting spacer element to the termination cell plate;
d. introducing a first electrolysis cell plate to the conducting spacer element with an electrically insulated grommet fitted to an aperture of the cell plate;
e. introducing an electrolysis cell plate to the conducting spacer element;
f. introducing an intermediate conducting spacer element which is adapted to interference fit to the conducting spacer element and subsequent intermediate conducting spacer elements;
g. introducing an electrolysis cell plate to the intermediate conducting spacer element with an electrically insulated grommet fitted to the electrolysis cell plate aperture;
h. introducing an electrolysis cell plate to the intermediate conducting spacer element;
i. repeating the process in steps f to h until the desired number of electrolysis cell plates is achieved;
j. introducing a final termination cell plate to the support member; and
k. introducing longitudinal pressure to press fit the conducting spacer elements and electrolysis cell plates in the electrolysis cell assembly;
l. introducing a second fastening device to the support member.

23. An electrolysis cell unit comprising a plurality of cell plates, formed by the method according to claim 22.

24. An electrolysis cell apparatus including a plurality of electrolysis cell units according to claims 23.

25.-47. (canceled)
